(19) United States
(12) Patent Application Publication
(10) Pub. No.: US 2013/0176346 A1
(43) Pub. Date: Jul. 11, 2013

(54) ELECTRONIC DEVICE AND METHOD FOR CONTROLLING DISPLAY ON THE ELECTRONIC DEVICE

(71) Applicant: CHIH-CHIEN CHEN, Shindian (TW)

(72) Inventor: CHIH-CHIEN CHEN, Shindian (TW)

(73) Assignee: FIH (HONG KONG) LIMITED, Kowloon (HK)

(21) Appl. No.: 13/533,984

(22) Filed: Jun. 27, 2012

(30) Foreign Application Priority Data
Jan. 11, 2012 (TW) 101101157

(51) Int. Cl. G09G 5/00

(52) U.S. Cl. 345/684

(57) ABSTRACT

An electronic device sets an initial position of an electronic device as a reference position. The electronic device uses a gravity sensor to acquire a tilt angle of the electronic device based on a current position of the electronic device and the reference position and a tilt direction of the electronic device. The electronic device determines a scrolling speed and a scrolling direction of a data page displayed on a screen of the electronic device according to the tilt angle and the tilt direction, and controls movements of the data page according to the scrolling speed and the scrolling direction.

### BACKGROUND

1. Technical Field

Embodiments of the present disclosure generally relate to electronic devices, and particularly to an electronic device and a method for controlling a display on the electronic device.

2. Description of Related Art

In one example, a prompt icon may be displayed on a screen of a computer when a user browses a webpage on a screen of a computer and manipulates a scroll wheel of a mouse of the computer. The user can put a cursor of the mouse on top of or on bottom of the prompting icon, to scroll up or scroll down the webpage. However, if the user browses the webpage on an electronic device without a mouse (e.g., a touch screen computer or a mobile phone), the user should scroll the webpage by sliding a finger or a stylus on a touch screen display of the electronic device.

### BRIEF DESCRIPTION OF THE DRAWINGS

FIG. 1 is a schematic diagram of one embodiment of an electronic device including a control unit for automatically controlling a display of a screen on the electronic device.

FIG. 2 is a block diagram of one embodiment of function modules of the control unit of the electronic device in FIG. 1.

FIG. 3 is a flowchart of one embodiment of a method for automatically controlling a display of a screen on the electronic device.

FIG. 4 is a schematic diagram of one embodiment of a webpage and a prompting icon displayed on a touch screen display of the electronic device.

FIG. 5A-5C are schematic diagrams of tilting up and tilting down the electronic device.

FIG. 6A-6B are schematic diagrams of a tilt angle between a current position and a reference position of the electronic device.

FIG. 7A-7B are schematic diagrams of scrolling up and scrolling down the webpage in FIG. 4.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

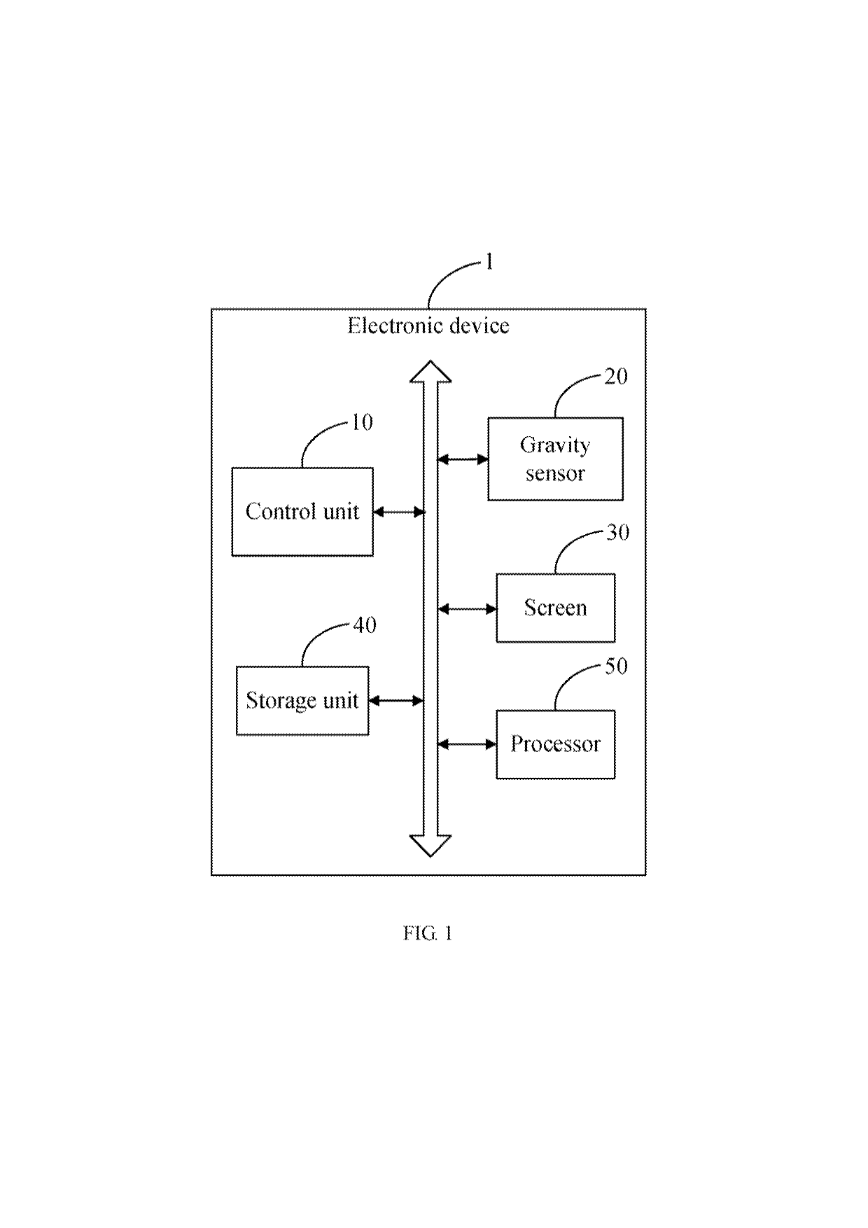

FIG. 1 is a schematic diagram of one embodiment of an electronic device 1 including a control unit 10 for automatically controlling a display of a screen 30 on the electronic device 1. In the embodiment, the electronic device 1 further includes a gravity sensor 20, a storage unit 40, and a processor 50. The electronic device 1 may be a touch screen computer or a mobile phone, for example.

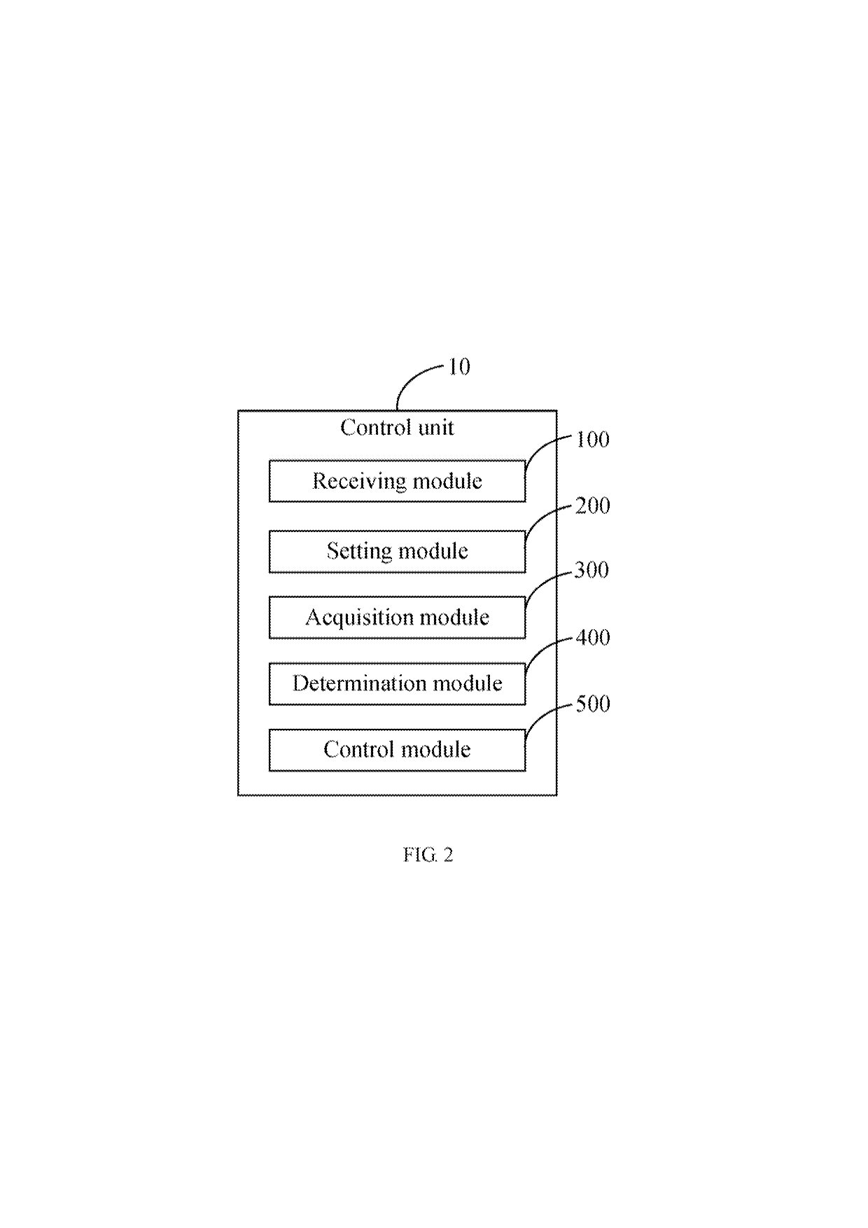

In one embodiment, the control unit 10 may include one or more function modules (a description is given in FIG. 2). The one or more function modules may comprise computerized code in the form of one or more programs that are stored in the storage unit 40, and executed by the processor 50 to provide the functions of the control unit 10. The storage unit 40 may be a cache or a dedicated memory, such as an EPROM or a flash memory.

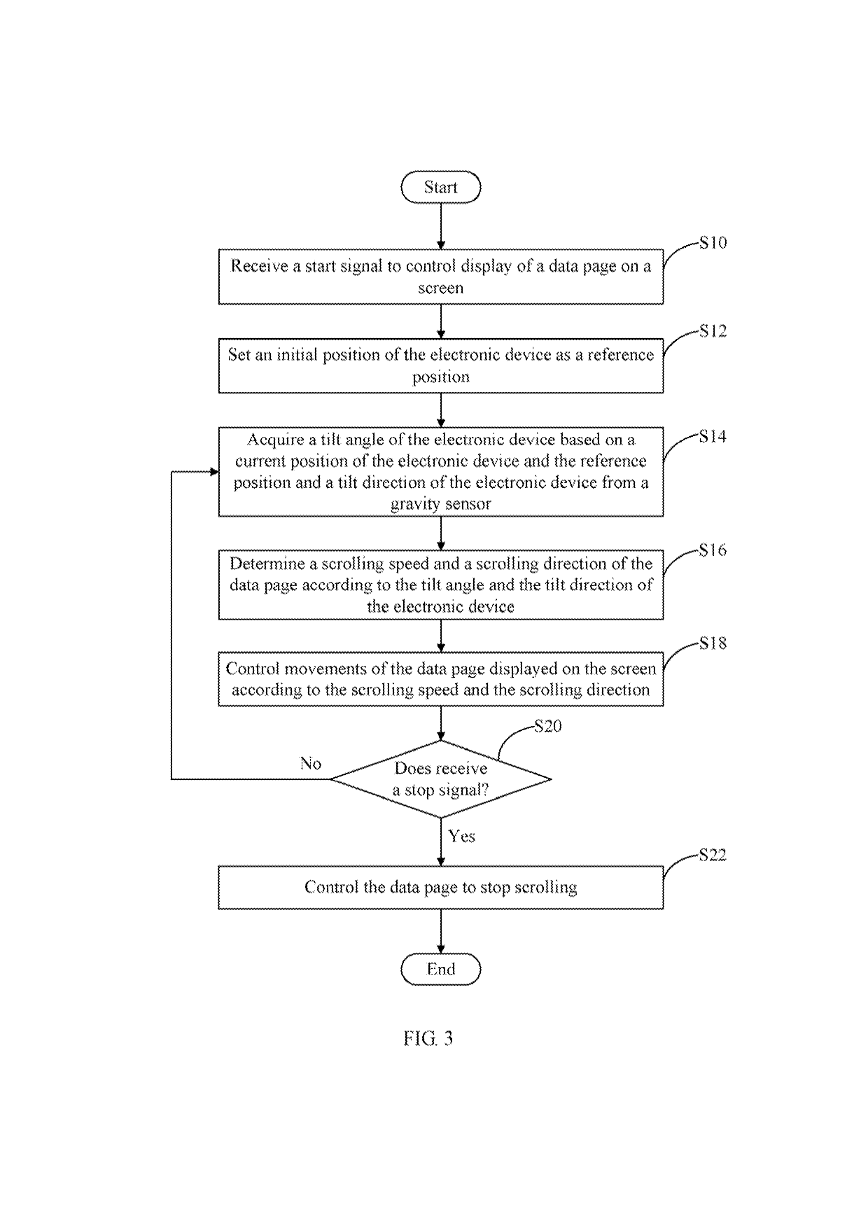

FIG. 2 is a block diagram of one embodiment of the function modules of the control unit 10. In one embodiment, the control unit 10 includes a receiving module 100, a setting module 200, an acquisition module 300, a determination module 400, and a control module 500. A detailed description of the functions of the modules 100-500 is given in FIG. 3.

FIG. 3 is a flowchart of one embodiment of a method for automatically controlling a display of the screen 30 on the electronic device 1. Depending on the embodiment, additional steps may be added, others removed, and the ordering of the steps may be changed.

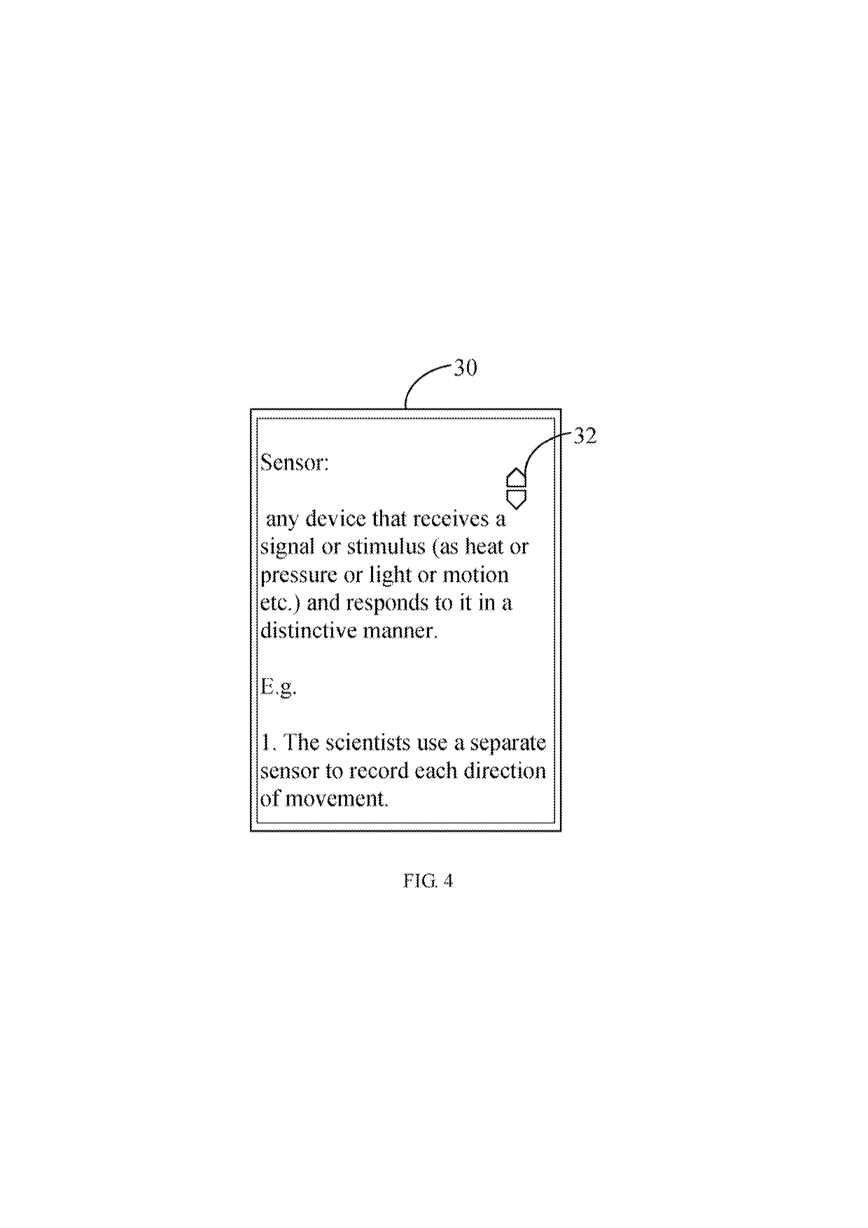

The user may select (via tapping) a prompting icon 32 displayed on the screen 30 (as shown in FIG. 4) in order to scroll a data page (e.g., a webpage or a picture) displayed on the screen 30. In response, in step S10, a start signal is input to the receiving module 100 to control display of the data page on the screen 30.

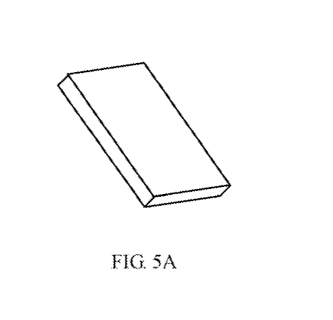

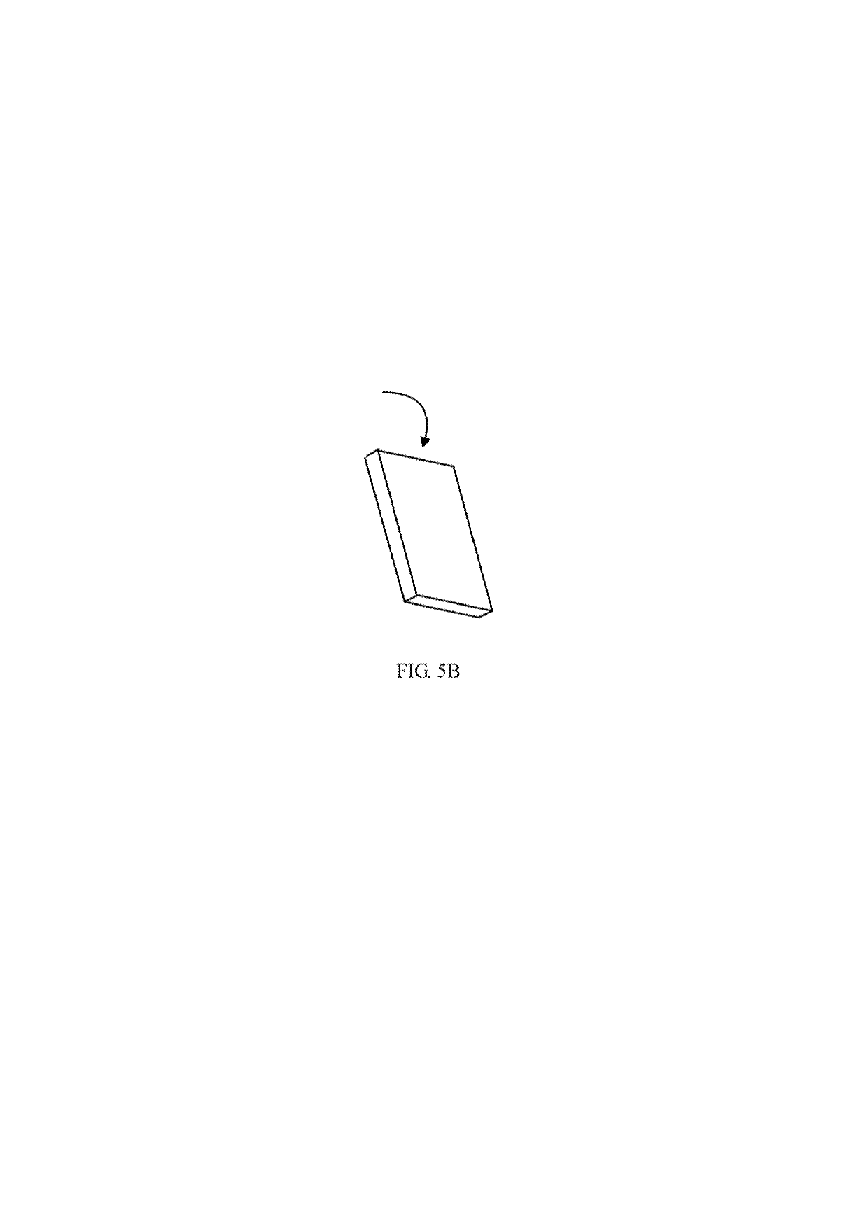

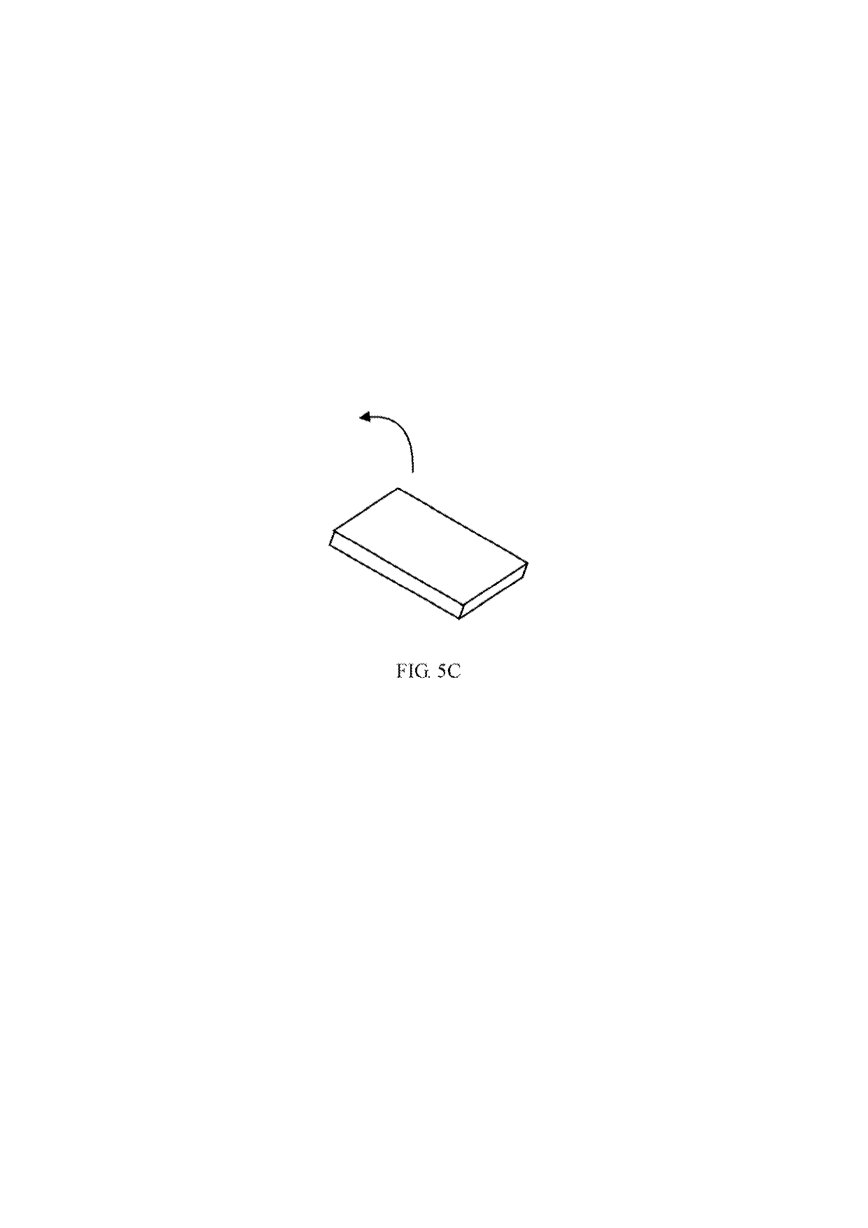

In step S12, the setting module 200 sets an initial position of the electronic device 1 as a reference position (as shown in FIG. 5A), in response that the receiving module 100 receives the start signal.

The gravity sensor 20 detects a tilt direction of the electronic device 1 when the user tilts up or tilts down the electronic device 1 to control display of the data page displayed on the screen 30. In step S14, the acquisition module 300 acquires a tilt angle of the electronic device 1 based on a current position of the electronic device 1 and the reference position and the tilt direction of the electronic device 1 from the gravity sensor 20. In the embodiment, the current position, the reference position, the tilt angle and the tilt direction of the electronic device 1 are stored in the storage unit 40.

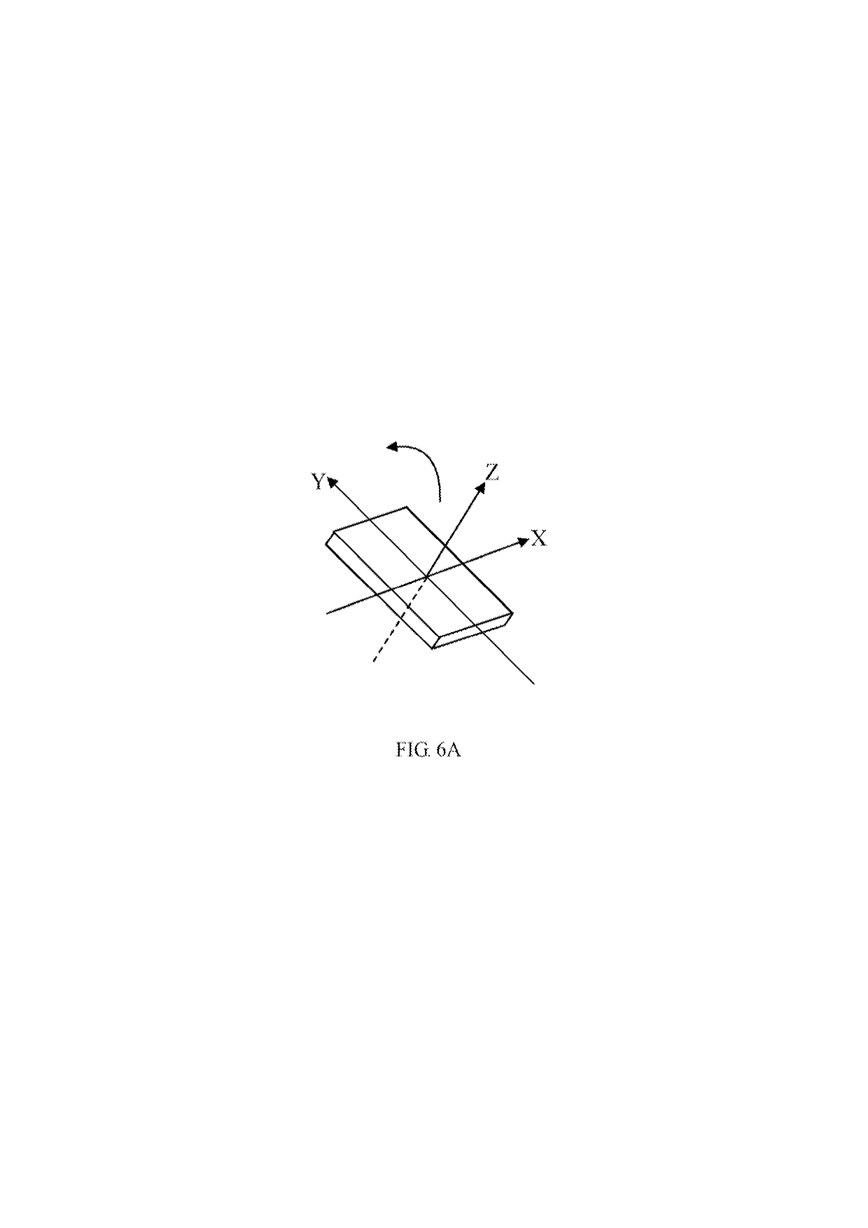

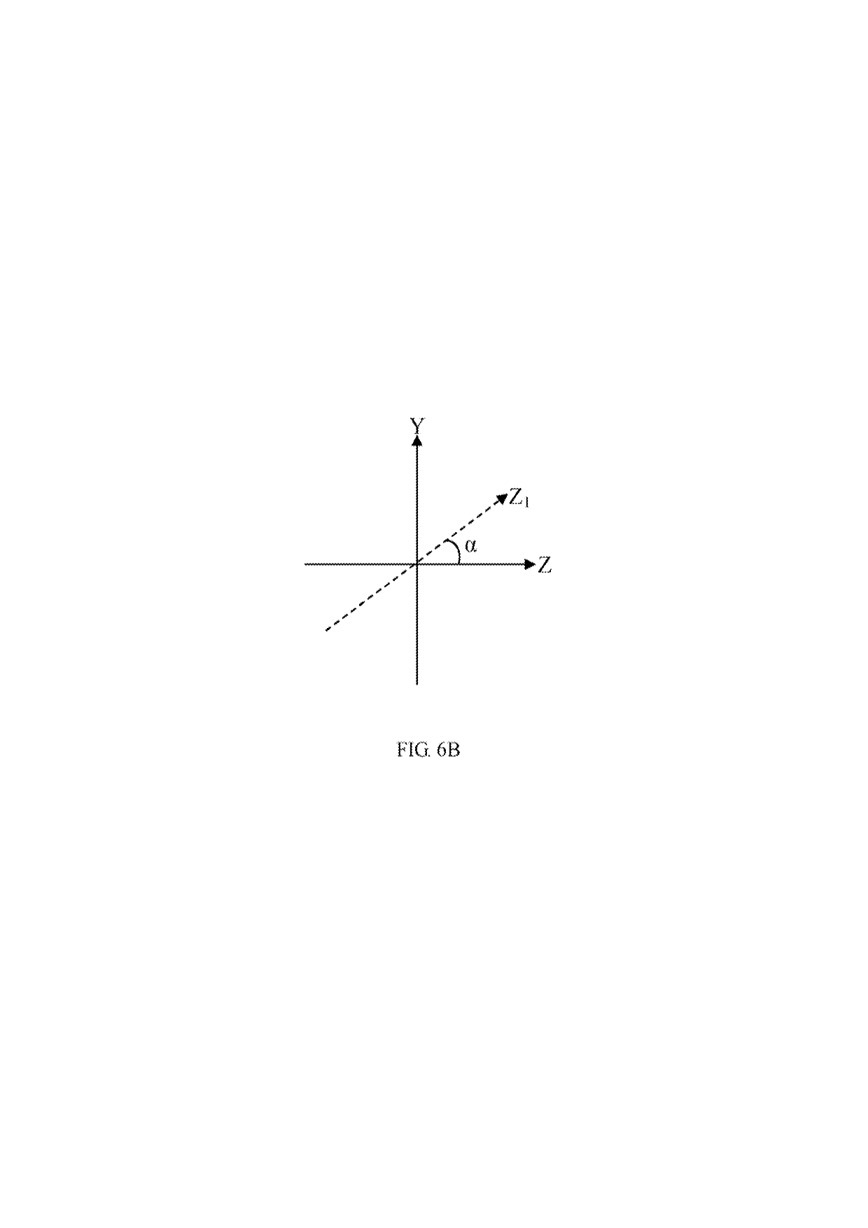

The tilt angle of the electronic device 1 may be a positive value or a negative value. In the embodiment, if the user tilts down the electronic device 1 from the reference position (as shown in FIG. 5B), the tilt angle is a positive value. If the user tilts up the electronic device 1 from the reference position (as shown in FIG. 5C), the tilt angle is a negative value. For example, in FIG. 6A, the screen 30 is at a XY plane, and a Z-axis is vertical with the screen 30. When the user tilts up the electronic device 1 along the X-axis, the Z-axis moves to the position of Z₁-axis (as shown in FIG. 6B), the tilt angle between the current position of the electronic device 1 and the reference position equals an angle α between the Z-axis and the Z₁-axis, and the angle α is negative.

In step S16, the determination module 400 determines a scrolling speed and a scrolling direction of the data page according to the tilt angle and the tilt direction of the electronic device 1. In the embodiment, if a preset maximal scrolling speed is Vₘ, the scrolling speed V of the data page is V=S*Vₘ, wherein the coefficient S is set according to the tilt angle. The coefficient S increases as the angle increases. If the tilt angle is 0 degrees, the coefficient S is 0. If the tilt angle is 45 degrees or more than 45 degrees, the coefficient S is 1.

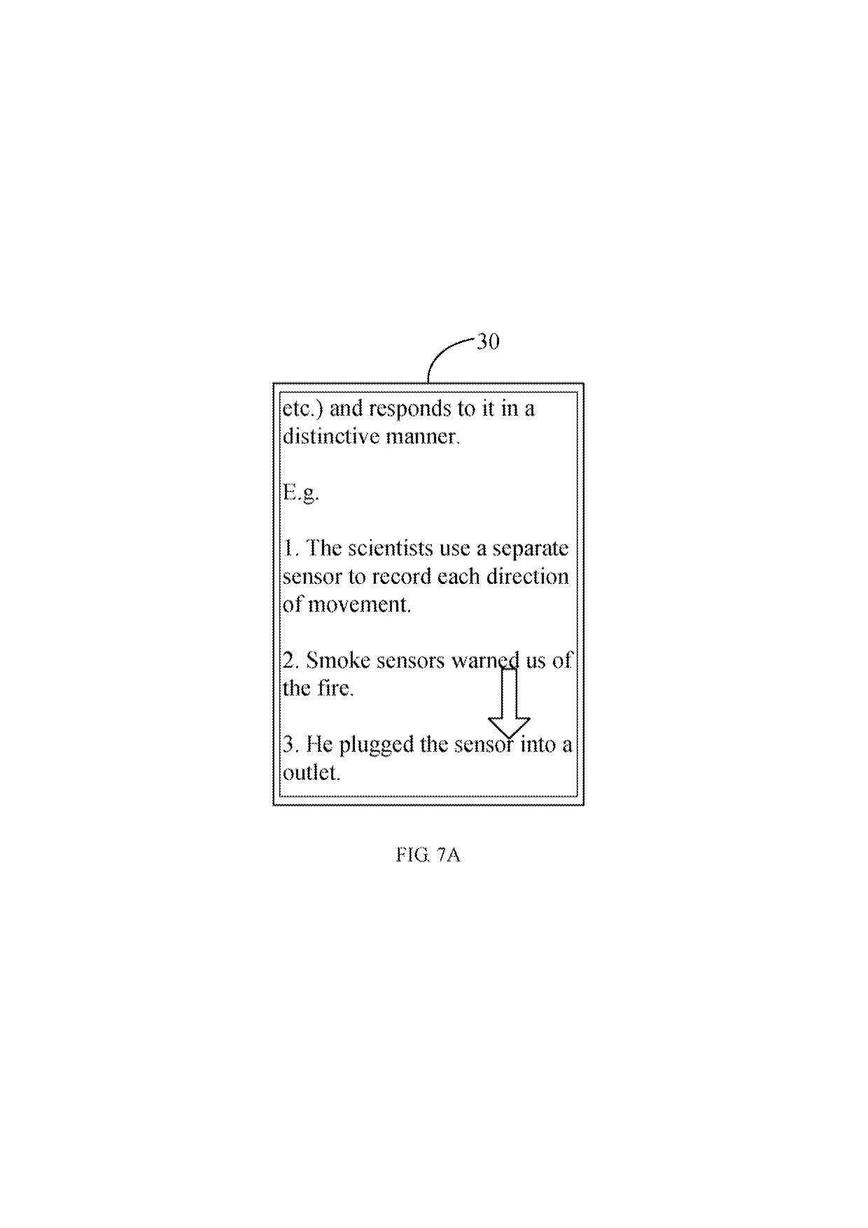

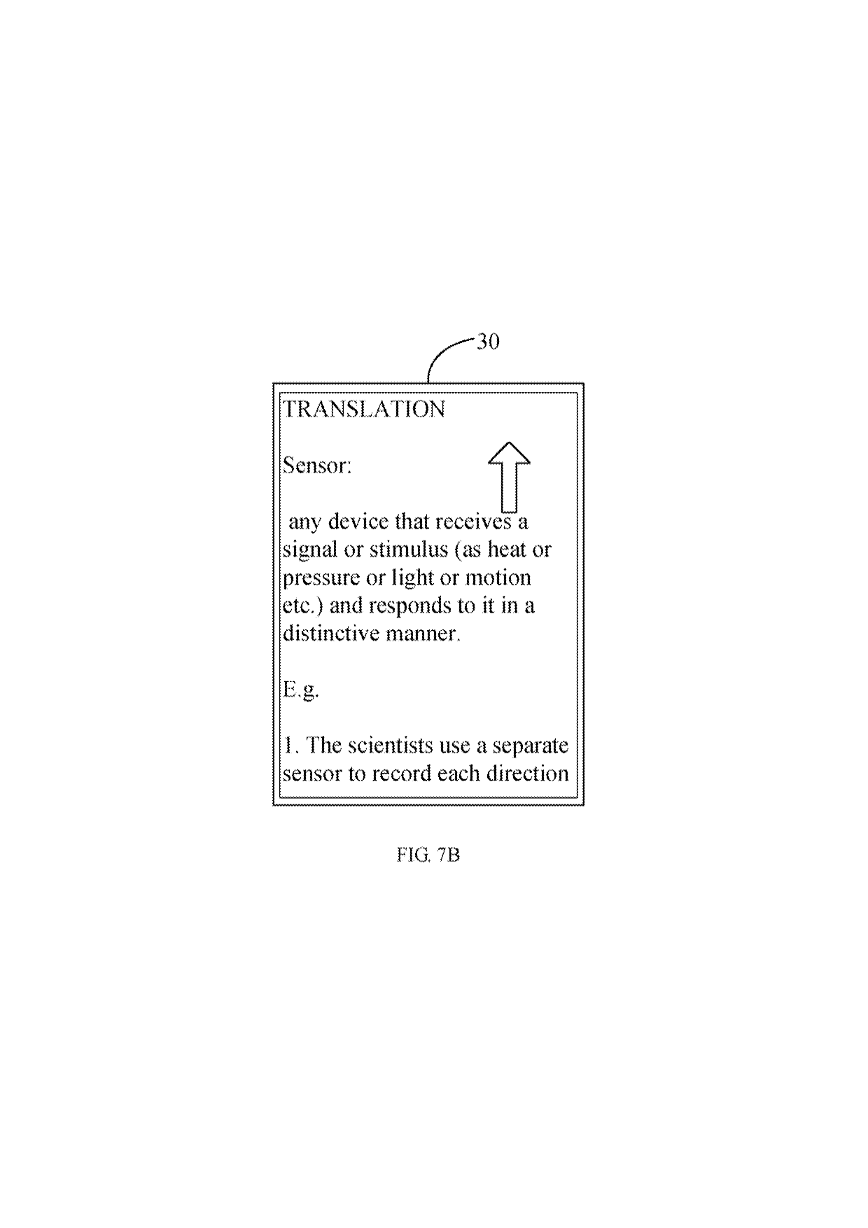

In the embodiment, if the tilt angle is positive, the determination module 400 determines that the data page should be scrolled down (as shown in FIG. 7A). If the tilt angle is negative, the determination module 400 determines that the data page should be scrolled up (as shown in FIG. 7B). In other embodiments, the determination module 400 may determine that the data page should be scrolled up when the tilt angle is positive and be scrolled down when the tilt angle is negative. It is understood that the scrolling direction of the data page can further include left and right, and their work principles are similar to scrolling up and scrolling down.

In step S18, the control module 500 controls movements of the data page displayed on the screen 30 according to the scrolling speed and the scrolling direction.

In step S20, the receiving module 100 receives a stop signal for inactivating the function of automatically controlling the display of the data page on the electronic device 1 input by the user. In the embodiment, the user sends a stop signal to the receiving module 100 by a preset operation, for example, touching the screen 30, to stop scrolling the data page. If the receiving module 100 does not receive the stop signal, the procedure returns to step S14.

In step S22, the control module 500 controls the data page to stop scrolling in response that the receiving module 100 receives the stop signal.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of an electronic device comprising a screen, the method comprising:
(a) in response to receiving a start signal to control display of a data page displayed on the screen of the electronic device, setting an initial position of the electronic device as a reference position;
(b) using a gravity sensor to acquire a tilt angle of the electronic device based on a current position of the electronic device and the reference position and a tilt direction of the electronic device;
(c) determining a scrolling speed and a scrolling direction of the data page displayed on the screen according to the tilt angle and the tilt direction of the electronic device; and
(d) controlling movements of the data page on the screen according to the scrolling speed and the scrolling direction.

2. The method as claimed in claim 1, wherein the method further comprising:
in response to receiving a stop signal for inactivating the function of automatically controlling the display of the data page on the electronic device, controlling the data page to stop scrolling.

3. The method as claimed in claim 1, wherein step (b) comprises:
determining the tilt angle is a positive value if the electronic device is tilted down from the reference position; and
determining the tilt angle is a negative value if the electronic device is tilted up from the reference position.

4. The method as claimed in claim 3, wherein step (c) comprising:
determining that the data page should be scrolled down on the screen if the tilt angle is positive; and
determining that the data page should be scrolled up on the screen if the tilt angle is negative.

5. The method as claimed in claim 1, wherein step (c) comprises:
determining the scrolling speed according to a formula V=S*Vₘ, wherein Vₘ represents a preset maximal scrolling speed, V represents the scrolling speed of the data page, and the coefficient S is set according to the tilt angle.

6. A non-transitory storage medium storing a set of instructions, the set of instructions capable of being executed by a processor of an electronic device comprising a screen, to perform a method for automatically controlling a display of the screen on the electronic device, the method comprising:
(a) in response to receiving a start signal to control display of a data page displayed on the screen of the electronic device, setting an initial position of the electronic device as a reference position;
(b) using a gravity sensor to acquire a tilt angle of the electronic device based on a current position of the electronic device and the reference position and a tilt direction of the electronic device;
(c) determining a scrolling speed and a scrolling direction of the data page displayed on the screen according to the tilt angle and the tilt direction of the electronic device; and
(d) controlling movements of the data page on the screen according to the scrolling speed and the scrolling direction.

7. The non-transitory storage medium as claimed in claim 6, wherein the method further comprising:
in response to receiving a stop signal for inactivating the function of automatically controlling the display of the data page on the electronic device, controlling the data page to stop scrolling.

8. The non-transitory storage medium as claimed in claim 6, wherein step (b) comprises:
determining the tilt angle is a positive value if the electronic device is tilted down from the reference position; and
determining the tilt angle is a negative value if the electronic device is tilted up from the reference position.

9. The non-transitory storage medium as claimed in claim 8, wherein step (c) comprising:
determining that the data page should be scrolled down on the screen if the tilt angle is positive; and
determining that the data page should be scrolled up on the screen if the tilt angle is negative.

10. The non-transitory storage medium as claimed in claim 6, wherein step (c) comprises:
determining the scrolling speed according to a formula V=S*Vₘ, wherein Vₘ represents a preset maximal scrolling speed, V represents the scrolling speed of the data page, and the coefficient S is set according to the tilt angle.

11. An electronic device, the electronic device comprising:
a gravity sensor;
a screen;
a storage unit;
at least one processor;
one or more programs that are stored in the storage unit and are executed by the at least one processor, the one or more programs comprising:
a setting module that sets an initial position of the electronic device as a reference position, in response to receiving a start signal to control display of a data page displayed on the screen of the electronic device;
an acquisition module that acquires a tilt angle of the electronic device based on a current position of the electronic device and the reference position and a tilt direction of the electronic device from the gravity sensor;
a determination module that determines a scrolling speed and a scrolling direction of the data page displayed on the screen according to the tilt angle and the tilt direction of the electronic device; and
a control module that controls movements of the data page on the screen according to the scrolling speed and the scrolling direction.

12. The electronic device as claimed in claim 11, wherein the control module further controls the data page to stop scrolling in response to receiving a stop signal for inactivating the function of automatically controlling the display of the data page on the electronic device.

13. The electronic device as claimed in claim 11, wherein if the electronic device is tilted down from the reference position, the tilt angle is a positive value; if the electronic device is tilted up from the reference position, the tilt angle is a negative value.

14. The electronic device as claimed in claim 13, wherein if the tilt angle is positive, the data page should be scrolled down on the screen; if the tilt angle is negative, the data page should be scrolled up on the screen.

15. The electronic device as claimed in claim 11, wherein the scrolling speed of the data page is determined according to a formula V=S*Vₘ, wherein Vₘ represents a preset maximal scrolling speed, V represents the scrolling speed of the data page, and the coefficient S is set according to the tilt angle.
